(19) United States
(12) Patent Application Publication
(10) Pub. No.: US 2013/0033191 A1
(43) Pub. Date: Feb. 7, 2013

(54) LIGHT EMITTING DIODE DRIVING DEVICE AND METHOD THEREOF

(71) Applicants: Joong Ho CHOI, Seongnam (KR); Seok Lee, Yongin (KR); Jae Hoon Kim, Seoul (KR); Jae Shin Lee, Anyang (KR); Yeun Joong Lee, Seoul (KR); Deuk Hee Park, Suwon (KR); Sang Hyun Cha, Seoul (KR); Chang Seok Lee, Seoul (KR); Jung Eui Park, Suwon (KR)

(72) Inventors: Joong Ho CHOI, Seongnam (KR); Seok Lee, Yongin (KR); Jae Hoon Kim, Seoul (KR); Jae Shin Lee, Anyang (KR); Yeun Joong Lee, Seoul (KR); Deuk Hee Park, Suwon (KR); Sang Hyun Cha, Seoul (KR); Chang Seok Lee, Seoul (KR); Jung Eui Park, Suwon (KR)

(73) Assignee: SAMSUNG ELECTRO-MECHANICS CO., LTD./University of Seoul Industry Cooperation Foundation

(21) Appl. No.: 13/278,867

(22) Filed: Oct. 21, 2011

(30) Foreign Application Priority Data
Aug. 4, 2011 (KR) 10-2011-0077687

(51) Int. Cl. H05B 37/02

(52) U.S. Cl. 315/224; 315/240

(57) ABSTRACT

There are provided a light emitting diode (LED) driving device allowing for an increase in an LED driving rate by discharging a charge stored in a capacitor during a certain period of time and a method thereof. The LED driving device includes: a driving unit detecting a current, as a voltage, the current flowing across an LED unit having at least one LED, controlling the current flowing across the LED unit according to a comparison result between the detected voltage and a reference voltage having a pre-set voltage level, and having a capacitor stabilizing an operation of the LED unit when the LED unit is driven; and a discharging unit discharging a charge stored in the capacitor during a pre-set discharge time when the LED unit is initially driven.

### CROSS-REFERENCE TO RELATED APPLICATIONS

This application claims the priority of Korean Patent Application No. 10-2011-0077687 filed on Aug. 4, 2011, in the Korean Intellectual Property Office, the disclosure of which is incorporated herein by reference.

### BACKGROUND OF THE INVENTION

1. Field of the Invention

The present invention relates to a light emitting diode driving device for driving a light emitting diode and a method thereof.

2. Description of the Related Art

In general, a cold cathode fluorescent lamp (CCFL) used as a light source of a backlight unit of a liquid crystal display (LCD) uses mercury gas, thereby leading to disadvantages such as the possibility of environmental pollution, slow response speeds, low color reproducibility and unsuitability for a light, thin, short, and small LCD panel.

Thus, recently, LEDs have been actively employed for display devices. Compared with CCFLs, the LEDs are environmentally-friendly, have a response speed in the range of a few nano-seconds to enable a high speed response and are thus effective for a video signal stream, are available for impulsive driving, have high color reproducibility, are capable of arbitrarily changing luminance, color temperature, or the like by adjusting the quantity of light emitted from red, green and blue versions thereof, and are suitable for a light, thin, short, and small LCD panel.

In a backlight unit employing such LEDs, an LED driving device for supplying a current to the LEDs to drive them is necessarily employed.

In order to enhance the stability of an operation of the LED driving device, in general, a capacitor may be connected to the end of the LED driving device; however, the driving of the LED driving device may be slow when a current charged in the capacitor has been discharged to a certain level.

### SUMMARY OF THE INVENTION

An aspect of the present invention provides a light emitting diode (LED) driving device capable of increasing an LED driving rate by discharging a charge stored in a capacitor during a certain period of time, and a method thereof.

According to an aspect of the present invention, there is provided a light emitting diode (LED) driving device including: a driving unit detecting a current, as a voltage, the current flowing across an LED unit having at least one LED, controlling the current flowing across the LED unit according to a comparison result between the detected voltage and a reference voltage having a pre-set voltage level, and having a capacitor stabilizing an operation of the LED unit when the LED unit is driven; and a discharging unit discharging a charge stored in the capacitor during a pre-set discharge time when the LED unit is driven.

The driving unit may include: a comparison unit supplying a switching signal according to the comparison result between the detected voltage and the reference voltage; a transistor turned on and turned off according to the switching signal to control a level of the current flowing across the LED unit; and a first resistor detecting the current flowing across the LED unit, wherein the capacitor is connected between an end of the LED unit and a ground.

The discharging unit may discharge the charge stored in the capacitor during the pre-set discharge time when the transistor is turned on.

The discharging unit may include: an inverter inverting a level of a pulse width modulation (PWM) signal from the outside; a first transistor receiving the switching signal at a gate thereof; a second transistor connected in series between a driving power terminal supplying a pre-set driving power and a drain of the first transistor, and receiving the PWM signal inverted by the inverter at a gate thereof; a third transistor connected between the end of the LED unit and the ground and having a gate connected between the drain of the first transistor and a drain of the second transistor; and a fourth transistor connected in parallel to the first transistor and receiving the PWM signal inverted by the inverter at a gate thereof.

The discharging unit may further include a resistor and a first capacitor delaying the switching signal from the comparison unit for a pre-set period of time and transferring the delayed switching signal to the gate of the first transistor.

When the PWM signal is a high level signal having a pre-set level, the fourth transistor may be turned off, the second transistor may be turned on, and the third transistor may be turned on, to thereby discharge the charge stored in the capacitor, and the first transistor may be turned on after being delayed for the pre-set period of time and interrupt the discharge path after the discharge time.

When the PWM signal may be a low level signal having a level lower than that of the high level signal, the fourth transistor may be turned on, the second transistor may be turned off, and the third transistor may be turned off, to thereby interrupt the discharge path.

According to another aspect of the present invention, there is provided method of driving a light emitting diode (LED), the method including: a driving operation of detecting a current, as a voltage, the current flowing across an LED unit having at least one LED, and controlling the current flowing across the LED unit according to a comparison result between the detected voltage and a reference voltage having a pre-set voltage level; and a discharging operation of discharging a charge stored in a capacitor stabilizing an operation of the LED unit when the LED unit is initially driven, during a pre-set discharge time.

In the discharging operation, the charge stored in the capacitor may be discharged during the pre-set discharge time when a transistor for driving the LED unit is turned on.

The discharging operation may include: inverting a level of a pulse width modulation (PWM) signal from the outside; and when the PWM signal is a high level signal having a pre-set level, discharging the charge stored in the capacitor by turning off a fourth transistor, turning on a second transistor, and turning on a third transistor, and interrupting a discharge path after the pre-set discharge time by turning on the first transistor after a delay thereof for a pre-set period of time, among the first transistor receiving a switching signal for driving the transistor at a gate thereof, the second transistor connected in series between a driving power terminal supplying a pre-set driving power and the first transistor, and receiving the inverted PWM signal at a gate thereof, the third transistor connected between an end of the LED unit and a ground and having a gate connected to drains of the first and second transistors, and the fourth transistor connected in parallel to the first transistor and receiving the inverted PWM signal at a gate thereof.

In the interrupting of the discharge path, when the PWM signal is a low level signal having a level lower than that of the high level signal, the fourth transistor may be turned on, the second transistor may be turned off, and the third transistor may be turned off to thereby interrupt the discharge path.

In the discharging operation, the switching signal may be delayed for the pre-set period of time and then transferred to the gate of the first transistor.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic configuration view of a light emitting diode (LED) driving device according to an embodiment of the present invention;

FIGS. 2A and 2B are graphs showing electrical characteristics of the LED driving device according to the embodiment of the present invention and a general LED driving device; and

FIGS. 3A and 3B are operational flow charts illustrating a method of driving an LED driving device according to an embodiment of the present invention.

### DETAILED DESCRIPTION OF THE PREFERRED EMBODIMENT

Embodiments of the present invention will now be described in detail with reference to the accompanying drawings.

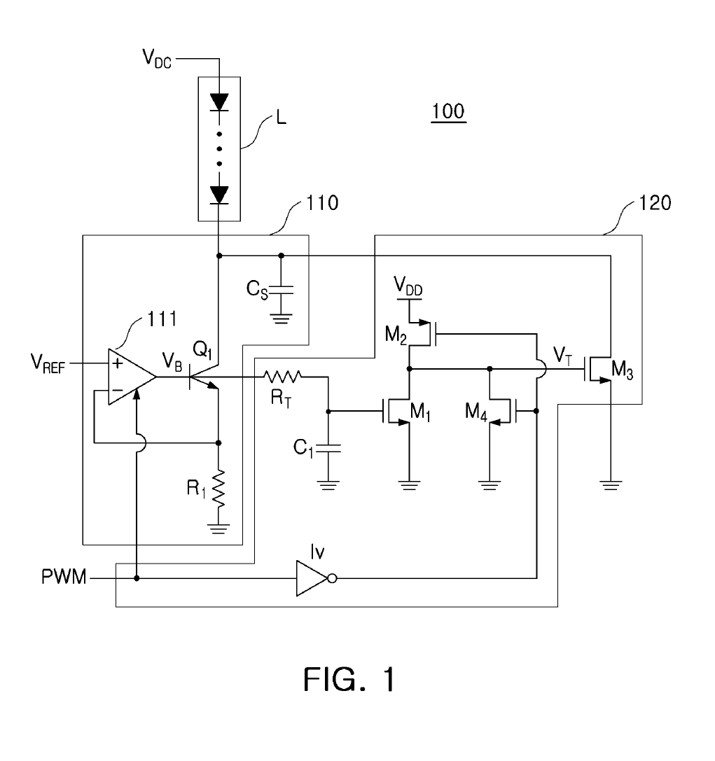

FIG. 1 is a schematic configuration view of a light emitting diode (LED) driving device according to an embodiment of the present invention.

With reference to FIG. 1, an LED driving device 100 according to an embodiment of the present invention may include a driving unit 110 and a discharging unit 120.

The driving unit 110 may control a current flowing across an LED unit L having at least one LED to thereby drive the LED unit L.

In detail, the LED unit L may include a single LED, an LED array having a plurality of LEDs connected in series, an LED group having a plurality of LEDs connected in parallel, or an LED group having a plurality of LED arrays connected in parallel, which receives a pre-set driving power V_{DC}.

Namely, the driving unit 110 may detect the current flowing across the LED unit L as a voltage, compare the level of the detected voltage with the level of a pre-set reference voltage, and control the current flowing across the LED unit L according to the comparison result to control a brightness of the LED unit L.

To this end, the driving unit 110 may include a comparison unit 111, a transistor Q₁, a first resistor R₁, and a capacitor Cs.

The comparison unit 111 may compare the level of the detected voltage with the level of the pre-set reference voltage, the transistor Q₁ may be connected between the other end, opposite to one end, of the LED unit L to which the driving power V_{DC} is inputted, and a ground, and may be turned on or turned off according to a switching signal V_{B} having a comparison result from the comparison unit 111 to control the current flowing across the LED unit L. The first resistor R₁ may be connected between the transistor Q₁ and the ground and controlled by the transistor Q₁ to thereby detect the current flowing across the LED unit Las a voltage value. The capacitor Cs removes a ripple of the current flowing across the LED unit L to allow the LEDs to be stably driven.

Meanwhile, when the transistor Q₁ is turned on after being turned-off, the turning on of the transistor Q1 may be delayed because a charge stored in the capacitor Cs may not have been sufficiently discharged.

When the driving unit 110 is driven, the discharging unit 120 may provide a discharge path for the charge stored in the capacitor Cs during a pre-set discharge time. Namely, the discharging unit 120 may provide a discharge path for the charge stored in the capacitor Cs during the discharge time when the transistor Q₁ is turned on.

To this end, the discharging unit 120 may include an inverter Iv, first to fourth transistors M₁, M₂, M₃, and M₄, a resistor R_{T}, and a first capacitor C₁.

The inverter Iv may invert the level of a pulse width modulation (PWM) signal supplied to the comparison unit 111 of the driving unit 110 and transfer the inverted PWM signal to gates of the second and fourth transistors M₂ and M₄.

The second transistor M₂ and the first transistor M₁ may be connected in series between a driving power terminal supplying a driving power V_{DD}, and the ground.

Namely, a source of the second transistor M₂ may receive the driving power V_{DD}, a gate thereof may receive the inverted PWM signal, and a drain thereof may be connected to a drain of the first transistor M₁ and a gate of the third transistor M₃. A gate of the first transistor M₁ may receive a switching signal V_{B} applied to the transistor Q₁, and a source thereof may be connected to the ground. Here, the switching signal V_{B} received to the gate of the first transistor M₁ may be a switching signal which has been RC delayed by the resistor R_{T} and the first capacitor C₁ and transferred to the gate of the first transistor M₁. Accordingly, the resistor R_{T} may be connected in series between a gate of the transistor Q₁ and the gate of the first transistor M₁, and the first capacitor C₁ may be connected in series between the gate of the first transistor M₁ and the ground.

A drain of the third transistor M₃ may be connected to the end of the LED unit L, and a source thereof may be connected to the ground. A drain of the fourth transistor M₄ may be connected to a drain of the second transistor M₂, and a source thereof may be connected to the ground.

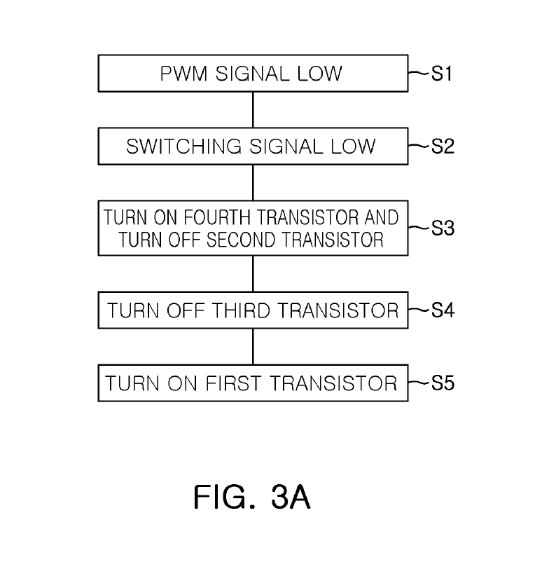

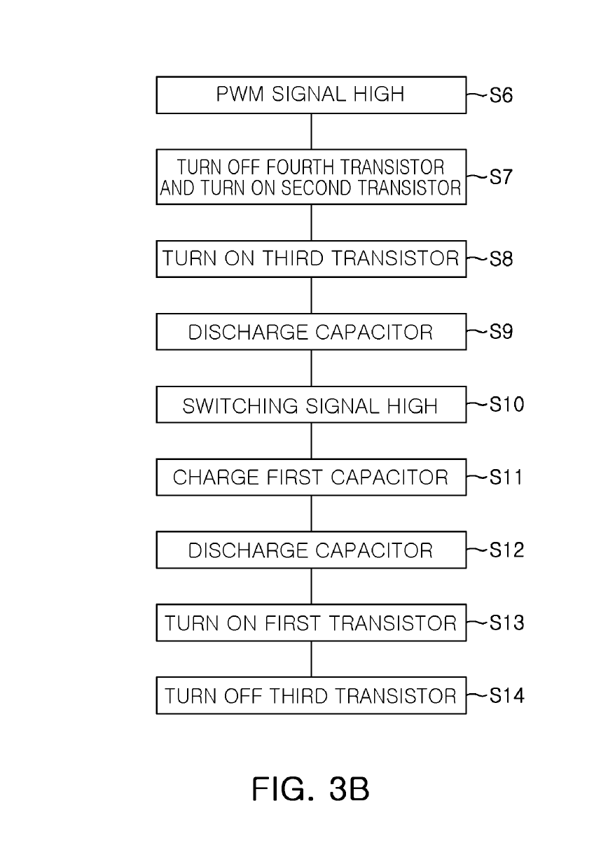

FIGS. 3A and 3B are operational flow charts illustrating a method of driving an LED driving device according to an embodiment of the present invention.

A discharging operation of the foregoing discharging unit 120 will now be described with reference to FIGS. 3A and 3B, together with FIG. 1.

First, when the level of the PWM signal is a low level lower than a pre-set level (S1), the switching signal V_{B} applied to the transistor Q₁ may be a low level signal (S2). Accordingly, the fourth transistor M₄ is turned on, the second transistor M₂ is turned off, and the level of a voltage applied to the gate of the third transistor M₃ is low level, such that the third transistor M₃ is turned off (S3 and S4). In addition, the first transistor M₁ is also turned off (S5). Namely, the discharge path is opened and a charge equal to a level of driving power V_{DC} may be stored in the capacitor Cs.

Next, when the level of the PWM signal is a high level higher than a pre-set level (S6), the level of the switching signal V_{B} rises, the fourth transistor M₄ is turned off, the second transistor M₂ is turned on, and thus the third transistor M₃ may be also turned on (S7 and S8). Accordingly, the discharge path is formed and a charge stored in the capacitor Cs may be discharged (S9). When the third transistor M₃ is continuously turned on, the current flowing across the LED unit L also flows through the third transistor M₃, to thereby result in degradation in power efficiency.

Thus, when the level of the PWM signal is a high level, the level of the switching signal V_{B} rises (S10), and a gate voltage of the first transistor M₁ is slowly increased by an RC delay circuit including the resistor R_{T} and the first capacitor C₁. Namely, after the second transistor M₂ is turned on and the charge stored in the capacitor Cs is discharged during a discharge time by the foregoing RC delay circuit (S11, S12), the first transistor M₁ may be turned on (S13).

When the first transistor M₁ is turned on, the third transistor M₃ is turned off, such that the formed discharge path may be opened (S14). In a section in which the first transistor M1 and the second transistor M2 are simultaneously turned on, the third transistor M3 needs to be turned off, such that a ratio (W/L) of a width to a length of the first transistor M1 may be considerably higher than that of the second transistor M2.

Namely, when the level of the PWM signal is a high level, the charge stored in the capacitor Cs may be discharged during the discharge time.

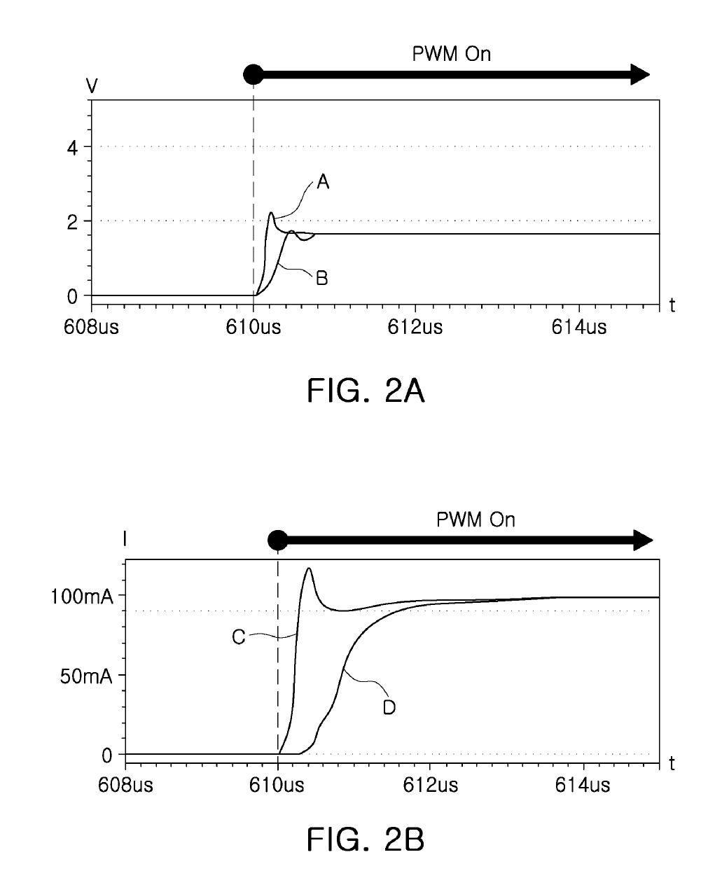

FIGS. 2A and 2B are graphs showing electrical characteristics of the LED driving device according to the embodiment of the present invention and a general LED driving device.

With reference to FIGS. 2A and 2B, together with FIG. 1, in the general LED driving device employing only the capacitor Cs, it can be seen that the voltage of the switching signal applied to the transistor Q₁ is slowly increased (B), such that the level of the current flowing across the LED unit L slowly rises (D).

On the other hand, in the LED driving device 100 according to the embodiment of the present invention, it can be seen that when the level of the PWM signal is a high level, the discharge path for the charge stored in the capacitor Cs is formed during the discharge time to allow the voltage of the switching signal applied to the transistor Q1 to be quickly increased (A), such that the level of the current flowing across the LED unit L rapidly rises (C).

As set forth above, according to embodiments of the invention, in driving an LED, a charge stored in a capacitor is discharged during a pre-set period of time, whereby the driving of the LED may be stably performed using the capacitor while increasing an LED driving speed.

While the present invention has been shown and described in connection with the embodiments, it will be apparent to those skilled in the art that modifications and variations can be made without departing from the spirit and scope of the invention as defined by the appended claims.

What is claimed is:

1. A light emitting diode (LED) driving device, comprising:
a driving unit detecting a current, as a voltage, the current flowing across an LED unit having at least one LED, controlling the current flowing across the LED unit according to a comparison result between the detected voltage and a reference voltage having a pre-set voltage level, and having a capacitor stabilizing an operation of the LED unit when the LED unit is driven; and
a discharging unit discharging a charge stored in the capacitor during a pre-set discharge time when the LED unit is driven.

2. The LED driving device of claim 1, wherein the driving unit includes:
a comparison unit supplying a switching signal according to the comparison result between the detected voltage and the reference voltage;
a transistor turned on and turned off according to the switching signal to control a level of the current flowing across the LED unit; and
a first resistor detecting the current flowing across the LED unit,
wherein the capacitor is connected between an end of the LED unit and a ground.

3. The LED driving device of claim 2, wherein the discharging unit discharges the charge stored in the capacitor during the pre-set discharge time when the transistor is turned on.

4. The LED driving device of claim 3, wherein the discharging unit includes:
an inverter inverting a level of a pulse width modulation (PWM) signal from the outside;
a first transistor receiving the switching signal at a gate thereof;
a second transistor connected in series between a driving power terminal supplying a pre-set driving power and a drain of the first transistor, and receiving the PWM signal inverted by the inverter at a gate thereof;
a third transistor connected between the end of the LED unit and the ground and having a gate connected between the drain of the first transistor and a drain of the second transistor; and
a fourth transistor connected in parallel to the first transistor and receiving the PWM signal inverted by the inverter at a gate thereof.

5. The LED driving device of claim 4, wherein the discharging unit further includes a resistor and a first capacitor delaying the switching signal from the comparison unit for a pre-set period of time and transferring the delayed switching signal to the gate of the first transistor.

6. The LED driving device of claim 5, wherein when the PWM signal is a high level signal having a pre-set level, the fourth transistor is turned off, the second transistor is turned on, and the third transistor is turned on, to thereby discharge the charge stored in the capacitor, and the first transistor is turned on after being delayed for the pre-set period of time and interrupts the discharge path after the discharge time.

7. The device of claim 6, wherein when the PWM signal is a low level signal having a level lower than that of the high level signal, the fourth transistor is turned on, the second transistor is turned off, and the third transistor is turned off, to thereby interrupt the discharge path.

8. A method of driving a light emitting diode (LED), the method comprising:
a driving operation of detecting a current, as a voltage, the current flowing across an LED unit having at least one LED, and controlling the current flowing across the LED unit according to a comparison result between the detected voltage and a reference voltage having a pre-set voltage level; and
a discharging operation of discharging a charge stored in a capacitor stabilizing an operation of the LED unit when the LED unit is initially driven, during a pre-set discharge time.

9. The method of claim 8, wherein, in the discharging operation, the charge stored in the capacitor is discharged during the pre-set discharge time when a transistor for driving the LED unit is turned on.

10. The method of claim 9, wherein the discharging operation includes:
inverting a level of a pulse width modulation (PWM) signal from the outside; and
when the PWM signal is a high level signal having a pre-set level, discharging the charge stored in the capacitor by turning off a fourth transistor, turning on a second transistor, and turning on a third transistor, and interrupting a discharge path after the pre-set discharge time by turning on the first transistor after a delay thereof for a pre-set period of time, among the first transistor receiving a switching signal for driving the transistor at a gate thereof, the second transistor connected in series between a driving power terminal supplying a pre-set driving power and the first transistor, and receiving the inverted PWM signal at a gate thereof, the third transistor connected between an end of the LED unit and a ground and having a gate connected to drains of the first and second transistors, and the fourth transistor connected in parallel to the first transistor and receiving the inverted PWM signal at a gate thereof.

11. The method of claim 10, wherein, in the interrupting of the discharge path, when the PWM signal is a low level signal having a level lower than that of the high level signal, the fourth transistor is turned on, the second transistor is turned off, and the third transistor is turned off to thereby interrupt the discharge path.

12. The method of claim 10, wherein, in the discharging operation, the switching signal is delayed for the pre-set period of time and then transferred to the gate of the first transistor.
